(19) United States
(12) Patent Application Publication
(10) Pub. No.: US 2018/0001560 A1
(43) Pub. Date: Jan. 4, 2018

(54) THREE-DIMENSIONAL PRINTING APPARATUS AND OBJECT-FORMATION-DATA PRODUCING APPARATUS

(71) Applicant: Roland DG Corporation, Hamamatsu-shi (JP)

(72) Inventor: Makoto YOSHIDA, Hamamatsu-shi (JP)

(21) Appl. No.: 15/635,240

(22) Filed: Jun. 28, 2017

(30) Foreign Application Priority Data
Jun. 29, 2016 (JP) 2016-128795

(51) Int. Cl. B29C 64/241; B29C 64/106; B33Y 30/00; B33Y 50/02

(52) U.S. Cl. CPC B29C 64/241; B33Y 50/02; B29C 64/106; B33Y 30/00

(57) ABSTRACT

A three-dimensional printing apparatus in which an amount of resin material used in forming a three-dimensional object is reduced, includes a core rod including a central shaft, a rotation mechanism that rotates the core rod about the central shaft, a guide rail extending above the core rod and along an axis of the core rod, a shaping head slidably provided on the guide rail and discharging a thermoplastic resin to the core rod, and a moving mechanism that moves the shaping head along the guide rail.

### CROSS REFERENCE TO RELATED APPLICATIONS

This application claims the benefit of priority to Japanese Patent Application No. 2016-128795 filed on Jun. 29, 2016. The entire contents of this application are hereby incorporated herein by reference.

### BACKGROUND OF THE INVENTION

### 1. Field of the Invention

The present invention relates to a three-dimensional printing apparatus and an object-formation-data producing apparatus. More particularly, the present invention relates to a three-dimensional printing apparatus and an object-formation-data producing apparatus that produce object formation data used in the three-dimensional printing apparatus.

### 2. Description of the Related Art

A three-dimensional printing apparatus is conventionally known in which resin layers each formed in a predetermined cross-sectional shape from a resin material are successively stacked and the resin material is cured to form a three-dimensional object (see, for example, JP 2000-280354 A). The three-dimensional printing apparatus of this type is furnished with a holder on which the resin layers are to be stacked, and the resin layers are successively formed upwardly on the holder, whereby a three-dimensional object is formed.

FIGS. 13A to 13C are schematic views illustrating a three-dimensional object 210 formed on a holder 250 according to conventional technology. FIG. 13A is a perspective view of the three-dimensional object 210. FIG. 13B is a plan view of the three-dimensional object 210. FIG. 13C is a front view of the three-dimensional object 210. As shown in FIG. 13C, it may be required to form a three-dimensional object 210 having a first main body portion 201 extending upward from the holder 250 and a second main body portion 202 disposed on the top end of the first main body portion 201. As illustrated in FIG. 13B, when viewed in plan, the diameter of the second main body portion 202 is greater than the diameter of the first main body portion 201. Such a three-dimensional object 210 may not be able to support the load of the outer peripheral portion of the second main body portion 202 during object formation. As a consequence, there is a risk that the three-dimensional object 210 may break. Conventionally, in order to prevent such breakage, a plurality of support objects 220 for supporting the load of the outer peripheral portion of the second main body portion 202 are formed between the holder 250 and the outer peripheral portion of the second main body portion 202 when forming the three-dimensional object 210, as illustrated in FIG. 13A. However, after the three-dimensional object 210 is formed, the support objects 220 need to be removed from the three-dimensional object 210. Because the resin material used for the support objects 220 is wasted, it is preferable that the number of the support objects 220 be as small as possible, or even zero.

### SUMMARY OF THE INVENTION

In view of the foregoing and other problems, preferred embodiments of the present invention provide three-dimensional printing apparatuses that reduce the amount of resin material used in forming a three-dimensional object, and provide object-formation-data producing apparatuses that produce object formation data used in the three-dimensional printing apparatuses.

A three-dimensional printing apparatus according to a preferred embodiment of the present invention includes a core rod, a rotation mechanism, a guide rail, a shaping head, and a moving mechanism. The core rod includes a central shaft. The rotation mechanism rotates the core rod about the central shaft. The guide rail extends above the core rod and along the axis of the core rod. The shaping head is slidably engaged with the guide rail and discharges a thermoplastic resin toward the core rod. The moving mechanism causes the shaping head to move along the guide rail.

The above-described three-dimensional printing apparatus is able to form a three-dimensional printing apparatus by stacking layers of a thermoplastic resin around the core rod while rotating the core rod. For example, even the three-dimensional object 210 as shown in FIG. 13A can be formed by arranging the core rod at a position inside the three-dimensional object 210 and extending along the vertical axis in FIG. 13A. In this case, the three-dimensional object 210 is formed so that the vertical axis in FIG. 13A extends along the axis of the central shaft. This eliminates the need to form support objects 220 such as shown in FIG. 13A. As a result, the amount of resin material used in forming a three-dimensional object is able to be reduced.

Various preferred embodiments of the present invention make it possible to provide three-dimensional printing apparatuses that reduce the amount of resin material used in forming a three-dimensional object, and to provide object-formation-data producing apparatuses that produce object formation data used in the three-dimensional printing apparatuses.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a conceptual view of a three-dimensional printing system according to a preferred embodiment of the present invention.

FIG. 2 is a perspective view illustrating a three-dimensional printing apparatus.

FIG. 3 is a block diagram of the three-dimensional printing apparatus.

FIG. 4 is a perspective view illustrating one example of a three-dimensional object.

FIG. 5 is a view illustrating the three-dimensional object as viewed in the direction A shown in FIG. 4.

FIG. 6 is a view illustrating the three-dimensional object as viewed in the direction B shown in FIG. 4.

FIG. 7 is a view illustrating the three-dimensional object of FIG. 5 that is rotated about a shaft.

FIG. 8A is a view illustrating object formation data indicative of a first layer.

FIG. 8B is a view illustrating object formation data indicative of a second layer.

FIG. 8C is a view illustrating object formation data indicative of a third layer.

FIG. 9 is a block diagram illustrating an object-formation-data producing apparatus.

FIG. 10 is a flowchart illustrating a procedure of producing object formation data.

FIG. 11A is a view illustrating cross-sectional shape data in an object formation region at a rotation angle of 0 degrees (360 degrees).

FIG. 11B is a view illustrating cross-sectional shape data in the object formation region at a rotation angle of 45 degrees.

FIG. 11C is a view illustrating cross-sectional shape data in the object formation region at a rotation angle of 90 degrees.

FIG. 12A is a view illustrating region data in the object formation region at a rotation angle of 0 degrees (360 degrees).

FIG. 12B is a view illustrating region data in the object formation region at a rotation angle of 45 degrees.

FIG. 12C is a view illustrating region data in the object formation region at a rotation angle of 90 degrees.

FIG. 13A is a perspective view illustrating a three-dimensional object formed on a holder according to conventional technology.

FIG. 13B is a plan view illustrating the three-dimensional object formed on the holder according to conventional technology.

FIG. 13C is a front view illustrating the three-dimensional object formed on the holder according to conventional technology.

### DETAILED DESCRIPTION OF THE PREFERRED EMBODIMENTS

Hereinbelow, three-dimensional printing systems including a three-dimensional printing apparatus and object-formation-data producing apparatuses according to preferred embodiments of the present invention will be described with reference to the drawings. The preferred embodiments described herein are not intended to limit the present invention. The features and components that exhibit the same effects are denoted by the same reference symbols, and repetitive description thereof may be omitted as appropriate.

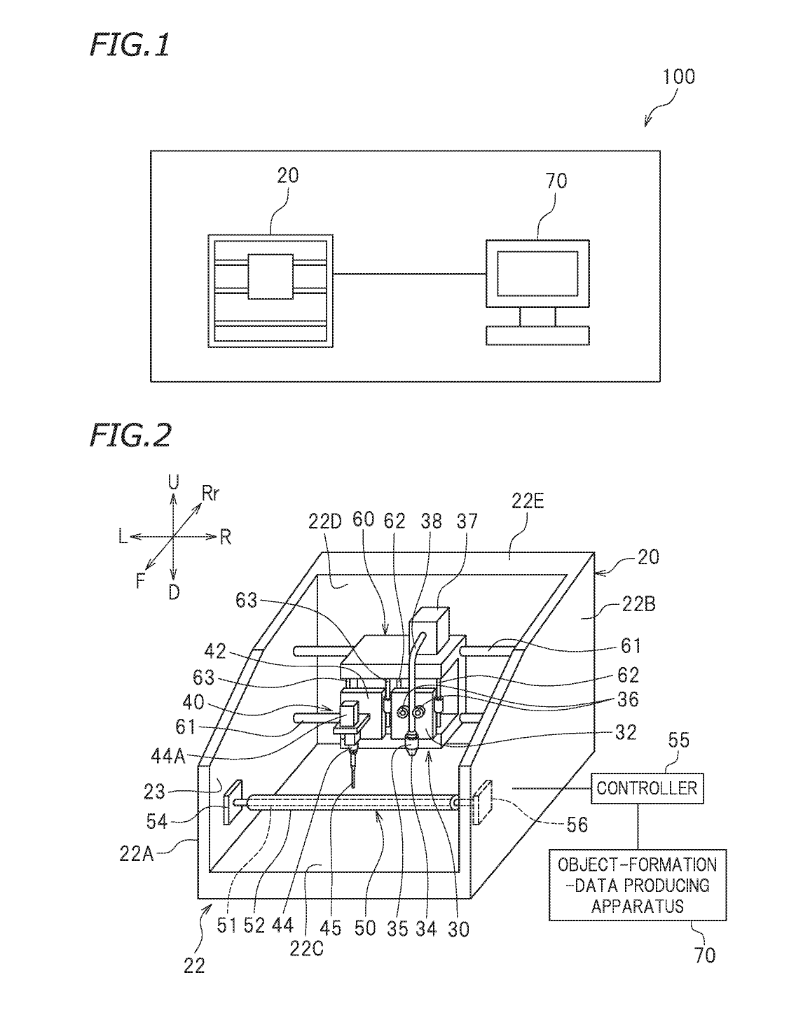

FIG. 1 is a conceptual view of a three-dimensional printing system 100 according to the present preferred embodiment. As illustrated in FIG. 1, the three-dimensional printing system 100 is a system that forms a three-dimensional object. The three-dimensional printing system 100 includes a three-dimensional printing apparatus 20 and an object-formation-data producing apparatus 70. The three-dimensional printing apparatus 20 and the object-formation-data producing apparatus 70 are electrically connected to each other.

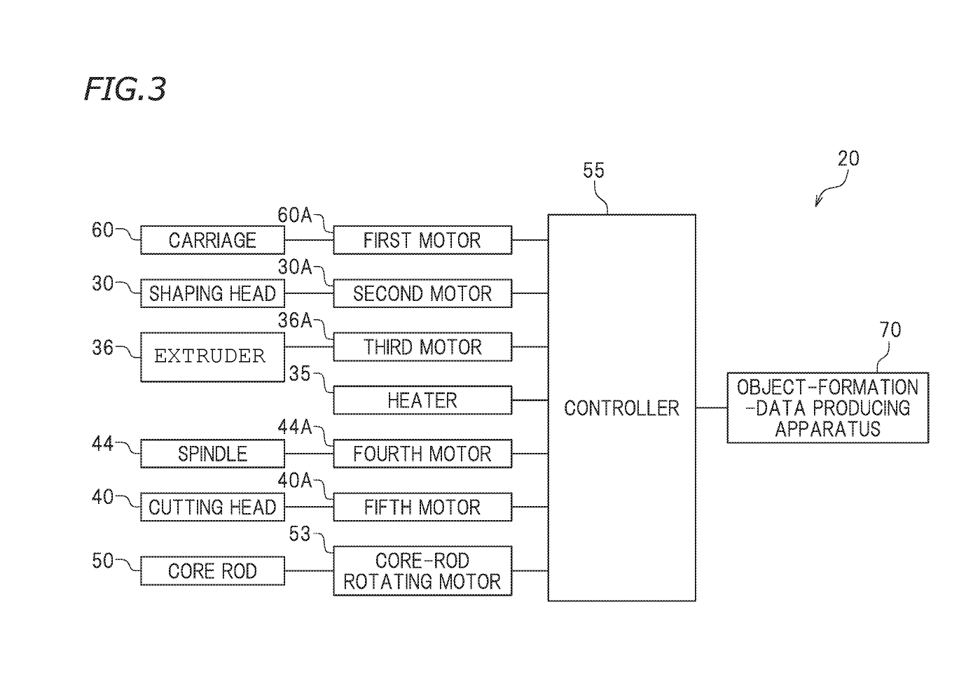

FIG. 2 is a perspective view illustrating the three-dimensional printing apparatus 20. The three-dimensional printing apparatus 20 is an apparatus that forms a desired three-dimensional object by successively stacking resin layers, each formed of a resin material, upwardly. The present preferred embodiment preferably uses a thermoplastic resin as the resin material. Herein, the term “thermoplastic resin” refers to a resin that softens when heated and solidifies when cooled.

In the following description, the terms “left,” “right,” “up,” and “down” respectively refer to left, right, up, and down as defined based on the perspective of the operator facing the three-dimensional printing apparatus 20. A direction approaching toward the operator relative to the three-dimensional printing apparatus 20 is defined as “frontward,” and a direction moving away from the operator relative to the cutting apparatus 10 is defined as “rearward.” Reference characters F, Rr, L, R, U, and D in the drawings represent front, rear, left, right, up, and down, respectively. These directional terms are, however, merely provided for purposes of illustration and are not intended to limit the preferred embodiments of the three-dimensional printing apparatus 20 in any way.

As illustrated in FIG. 2, the three-dimensional printing apparatus 20 includes a housing 22, a shaping head 30, a cutting head 40, a core rod 50, a controller 55, a carriage 60, and first guide rails 61. The housing 22 includes a left side wall 22A, a right side wall 22B, a bottom wall 22C, a rear wall 22D, and a top wall 22E. The lower end of the left side wall 22A is connected to the left end of the bottom wall 22C. The lower end of the right side wall 22B is connected to the right end of the bottom wall 22C. The lower end of the rear wall 22D is connected to the rear end of the bottom wall 22C. The left end of the rear wall 22D is connected to the rear end of the left side wall 22A. The right end of the rear wall 22D is connected to the rear end of the right side wall 22B. The top wall 22E is disposed above a rear portion of the bottom wall 22C. The top wall 22E is connected to the upper end of a rear portion of the left side wall 22A, the upper end of a rear portion of the right side wall 22B, and the upper end of the rear wall 22D.

In the present preferred embodiment, the housing 22 includes an opening 23 extending from its top toward the front. The opening 23 is surrounded by the left side wall 22A, the right side wall 22B, the bottom wall 22C, and the top wall 22E. Although not shown in the drawings, the housing 22 is provided with a cover that covers the opening 23.

Two first guide rails 61 are disposed in the housing 22. Each of the first guide rails 61 is a member extending along the lateral axis of the apparatus. The left ends of the first guide rails 61 are connected to the left side wall 22A. The right ends of the first guide rails 61 are connected to the right side wall 22B. In the present preferred embodiment, the number of first guide rails 61 is not limited. For example, it is possible that the three-dimensional printing apparatus 20 may include only one first guide rail 61. In the present preferred embodiment, the first guide rails 61 corresponds to a “guide rail”.

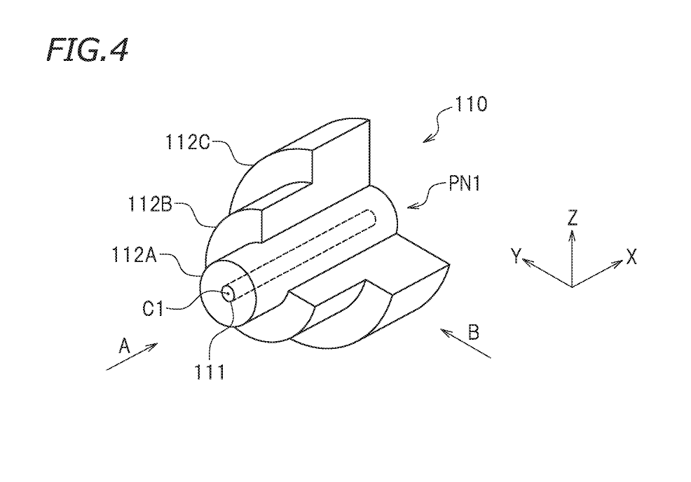

The carriage 60 is disposed in the housing 22. The carriage 60 is mounted slidably to the pair of first guide rails 61. The carriage 60 is movable in leftward and rightward directions along the pair of first guide rails 61. In the present preferred embodiment, a first motor 60A (see FIG. 3) is connected to the carriage 60. The carriage 60 receives the driving force of the first motor 60A and moves in leftward and rightward directions.

In the present preferred embodiment, the carriage 60 includes a pair of second guide rails 62 and a pair of third guide rails 63. The pair of second guide rails 62 and the pair of the third guide rails 63 are members extending vertically. Herein, the pair of second guide rails 62 are disposed to the right of the pair of third guide rails 63.

Next, the shaping head 30 will be described. The shaping head 30 discharges a thermoplastic resin 38. As illustrated in FIG. 2, the shaping head 30 is disposed in the housing 22. In the present preferred embodiment, the shaping head 30 is mounted to the carriage 60. Being driven by the first motor 60A, the carriage 60 moves in leftward and rightward directions, and the shaping head 30 accordingly moves in leftward and rightward directions. The first motor 60A moves the shaping head 30 along the first guide rails 61. Herein, the first motor 60A corresponds to a “moving mechanism”.

The shaping head 30 is mounted slidably to the pair of second guide rails 62 of the carriage 60. The shaping head 30 is movable in upward and downward directions along the second guide rails 62.

In the present preferred embodiment, the shaping head includes a shaping head main portion 32, a nozzle 34 that discharges the thermoplastic resin 38, a heater 35, and a pair of extruders 36. The shaping head main portion 32 is mounted slidably to the pair of first guide rails 62. A second motor 30A (see FIG. 3) is connected to the shaping head main portion 32. The shaping head main portion 32 receives the driving force of the second motor 30A and moves in upward and downward directions along the pair of second guide rails 62. This enables the shaping head 30 to move in upward and downward directions.

In the present preferred embodiment, a cartridge 37 is disposed above the carriage 60. The cartridge 37 accommodates the thermoplastic resin 38. The nozzle 34 discharges the thermoplastic resin 38, which is delivered from the cartridge 37, toward the core rod 50. The nozzle 34 discharges the thermoplastic resin 38 downwardly. Herein, the nozzle diameter of the nozzle 34 preferably is variable. Increasing the nozzle diameter results in quicker formation of the three-dimensional object. Reducing the nozzle diameter results in higher precision in forming the three-dimensional object.

The heater 35 applies heat to the thermoplastic resin 38 delivered from the cartridge 37. Herein, the heater 35 is mounted to a front portion of the shaping head main portion 32. However, the mount position of the heater 35 is not limited thereto. The heater 35 is disposed upward relative to the nozzle 34. The pair of extruders 36 deliver the thermoplastic resin 38, which is accommodated in the cartridge 37, to the nozzle 34. The pair of extruders 36 are provided on the shaping head main portion 32. The pair of extruders 36 are spaced apart from each other. Herein, a third motor 36A is connected to the extruders 36. By receiving the driving force of the third motor 36A, the extruders 36 rotate. The thermoplastic resin 38, which has been accommodated in the cartridge 37, passes through the gap between the pair of extruders 36. Then, because of the rotation of the extruders 36, the thermoplastic resin 38 is delivered to the nozzle 34 and thereafter discharged from the nozzle 34 to the core rod 50. The thermoplastic resin 38 is softened by the heat from the heater 35. This allows the thermoplastic resin 38 to be discharged onto the core rod 50 in a soft state. The thermoplastic resin 38 discharged on the core rod 50 is thereafter cured.

Next, the cutting head 40 will be described. The cutting head 40 processes the surface of the three-dimensional object that is formed by the cured thermoplastic resin 38. As illustrated in FIG. 2, the cutting head 40 is disposed in the housing 22. The cutting head 40 is mounted to the carriage 60. As the carriage 60 moves in leftward and rightward directions, the cutting head 40 accordingly moves in leftward and rightward directions. In the present preferred embodiment, the cutting head 40 is mounted slidably to the pair of third guide rails 63 of the carriage 60. The cutting head 40 is disposed leftward relative to the shaping head 30.

In the present preferred embodiment, the cutting head includes a cutting head main portion 42, a spindle 44, a processing tool 45 detachably attached to the spindle 44, and a fourth motor 44A to rotate the spindle 44. The cutting head main portion 42 is mounted slidably to the pair of third guide rails 63. Herein, a fifth motor 40A (see FIG. 3) is connected to the cutting head main portion 42. The cutting head main portion 42 receives the driving force of the fifth motor 40A and moves in upward and downward directions. This enables the cutting head 40 to move in upward and downward directions.

The spindle 44 causes the processing tool 45 to rotate. The spindle 44 is mounted to the cutting head main portion 42. The fourth motor 44A is mounted to an upper portion of the cutting head main portion 42. The fourth motor 44A is disposed upward relative to the spindle 44.

Next, the core rod 50 will be described below. The core rod 50 retains the thermoplastic resin 38 discharged from the nozzle 34 of the shaping head 30. Layers of the cured thermoplastic resin 38 are successively stacked around the core-rod 50, so that a three-dimensional object is formed. In the present preferred embodiment, the core rod 50 includes a central shaft 51 and a core-rod main body 52. The central shaft 51 extends along the lateral axis. Herein, the lateral axis is in agreement with the axis of the central shaft 51. However, it is possible that the central shaft 51 may extend along the fore-and-aft axis of the apparatus. The core-rod main body 52 is provided around the central shaft 51. Herein, layers of the thermoplastic resin 38 are successively stacked on the surface of the core-rod main body 52.

In the present preferred embodiment, the core rod 50 is disposed in the housing 22. The core rod 50 is disposed below the cutting head 40 and the first guide rails 61. The core rod 50 is disposed below the nozzle 34 of the shaping head 30. The axis along which the core rod 50 extends is in agreement with the axis along which the pair of first guide rails 61 extends.

The core rod 50 is detachable from the housing 22. In the present preferred embodiment, the three-dimensional printing apparatus 20 includes a first support member 54 and a second support member 56. The first support member 54 and the second support member 56 support the core rod 50. The housing 22 supports the core rod 50 via the first support member 54 and the second support member 56. The first support member 54 is disposed below the shaping head 30 and the cutting head 40, and provided on the left side wall 22A of the housing 22. The second support member 56 is disposed below the shaping head 30 and the cutting head 40, and provided on the right side wall 22B of the housing 22. The left end of the core rod 50 is supported by the first support member 54. The right end of the core rod 50 is supported by the second support member 56. In the present preferred embodiment, the core rod 50 is made of resin. That is, the central shaft 51 and the core-rod main body 52 are made of resin. However, the material that forms the core rod 50 is not limited to a particular material.

The core rod 50 is rotatable about the central shaft 51. The left end of the central shaft 51 is rotatable relative to the first support member 54. The right end of the central shaft 51 is rotatable relative to the second support member 56. In the present preferred embodiment, the three-dimensional printing apparatus 20 includes a core-rod rotating motor 53 (see FIG. 3). The core-rod rotating motor 53 rotates the core rod 50 about the central shaft 51. The core-rod rotating motor 53 is connected to the central shaft 51 of the core rod 50. Being driven by the core-rod rotating motor 53, the core rod 50 rotates about the central shaft 51 relative to the housing 22. In the present preferred embodiment, the core-rod rotating motor 53 is an example of the “rotation mechanism”.

Next, the controller 55 will be described. The controller 55 preferably is a computer, which includes a central processing unit (hereinafter also referred to as “CPU”), a ROM that stores programs or the like that are to be executed by the CPU, and a RAM, for example. However, the configuration of the controller 55 is not limited to specific configurations.

FIG. 3 is a block diagram of the three-dimensional printing system 100. As illustrated in FIG. 3, the controller 55 is electrically connected to the following components: the first motor 60A connected to the carriage 60, the second motor 30A connected to the shaping head 30 (more specifically, the shaping head main portion 32), the third motor 36A connected to the extruders 36 of the shaping head 30, the fourth motor 44A for rotating the spindle 44 of the cutting head 40, the fifth motor 40A connected to the cutting head 40 (more specifically, the cutting head main portion 42), the heater 35 of the shaping head 30, and the core-rod rotating motor 52. The controller 55 controls the operation of the first motor 60A to control leftward and rightward movements of the carriage 60. Along with the movement of the carriage 60, the controller 55 controls leftward and rightward movements of the shaping head 30 and the cutting head 40. The controller 55 controls the operation of the second motor 30A to control upward and downward movements of the shaping head 30. The controller 55 controls the third motor 36A to control rotation of the extruders 36. In association with rotation of the extruders 36, the thermoplastic resin 38 is delivered toward the nozzle 34. The controller 55 controls the delivering of the thermoplastic resin 38 to the nozzle 34. The controller 55 controls the operation of the fourth motor 44A to control rotation of the spindle 44 of the cutting head 40. The controller 55 controls the operation of the fifth motor 40A to control upward and downward movements of the cutting head 40. The controller 55 controls the heat produced by the heater 35 to adjust the degree of hardening of the thermoplastic resin 38. The controller 55 controls the operation of the core-rod rotating motor 53 to control rotation of the core rod 50.

Hereinabove, the three-dimensional printing apparatus 20 has been described. The three-dimensional printing apparatus 20 forms an object by using object formation data that are produced based on data of a desired three-dimensional object. The data of the three-dimensional object are three-dimensional data. However, the data of the three-dimensional object may be two-dimensional data. For example, the three-dimensional printing apparatus disclosed in JP 2000-280354 A uses slice data representative of cross-sectional shapes of a three-dimensional object sliced every predetermined thickness. Resin layers having the cross-sectional shapes corresponding to the slice data are successively stacked, so that the three-dimensional object is able to be formed. The slice data serve as the object formation data in the three-dimensional printing apparatus disclosed in JP 2000-280354 A.

On the other hand, in the three-dimensional printing apparatus 20 according to the present preferred embodiment, resin layers formed of the thermoplastic resin 38 are stacked around the core rod 50 by rotating the core rod 50. Then, the thermoplastic resin 38 is cured, so that a desired three-dimensional object is able to be formed. Thus, the three-dimensional printing apparatus according to the present preferred embodiment and the conventional three-dimensional printing apparatus require different procedures for forming a three-dimensional object. This means that the present preferred embodiment cannot use, as the object formation data, the slice data in which a three-dimensional object is sliced at every predetermined thickness. In order to form a three-dimensional object with the three-dimensional printing apparatus 20 according to the present preferred embodiment, it is desirable to use such object formation data as described below.

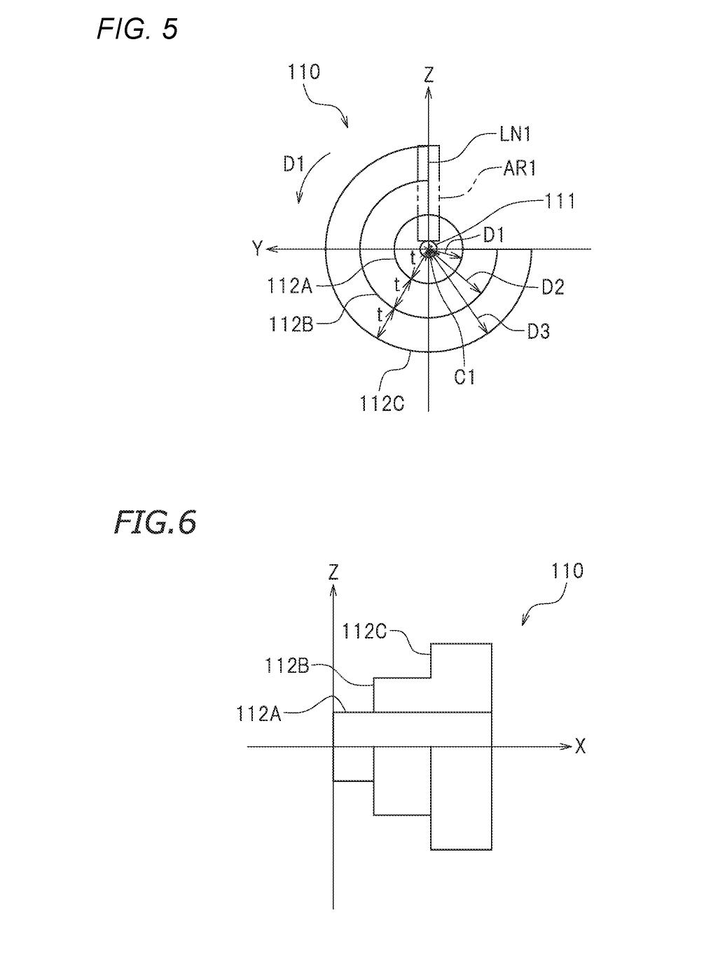

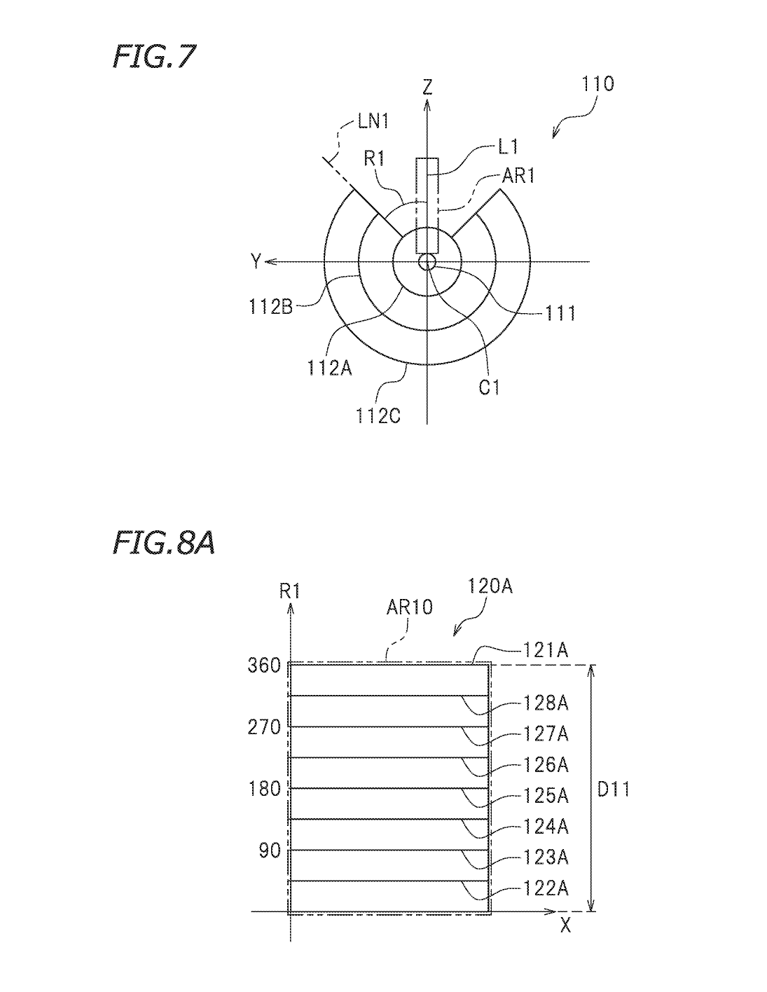

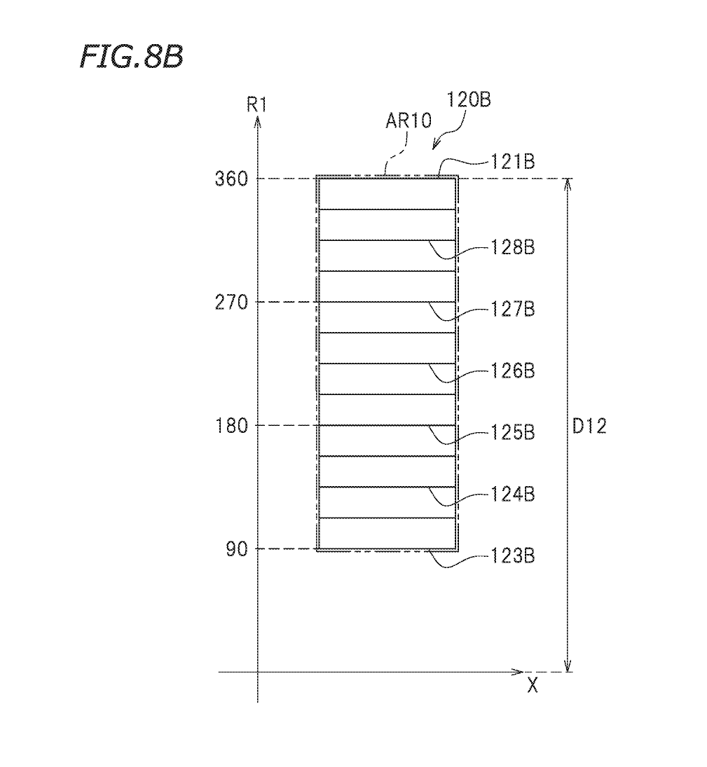

FIG. 4 shows one example of a three-dimensional object 110. FIG. 4 is a perspective view of the three-dimensional object 110. FIG. 5 is a view illustrating the three-dimensional object 110 as viewed in the direction A shown in FIG. 4. FIG. 6 is a view illustrating the three-dimensional object 110 as viewed in the direction B shown in FIG. 4. As illustrated in FIG. 4, the three-dimensional object 110 is assumed to be disposed in XYZ space, in which the X-axis, the Y-axis, and the Z-axis are orthogonal to each other. Herein, the three-dimensional object 110 includes a shaft 111, a first layer 112A, a second layer 112B, and a third layer 112C. The shaft 111 extends along the X-axis. When the object is formed by the three-dimensional printing apparatus 20, the core rod 50 (see FIG. 2) is disposed at a position corresponding to the shaft 111. As illustrated in FIG. 5, the plurality of layers 112A, 112B, and 112C are stacked around the shaft 111 in the following order: the first layer 112A, the second layer 112B, and the third layer 112C. The three-dimensional object 110 shown in FIG. 4 preferably includes three layers. However, the number of the layers is not limited thereto. In an actual situation, for example, a plurality of layers each having a thickness of about 0.05 mm to about 0.15 mm may be stacked.

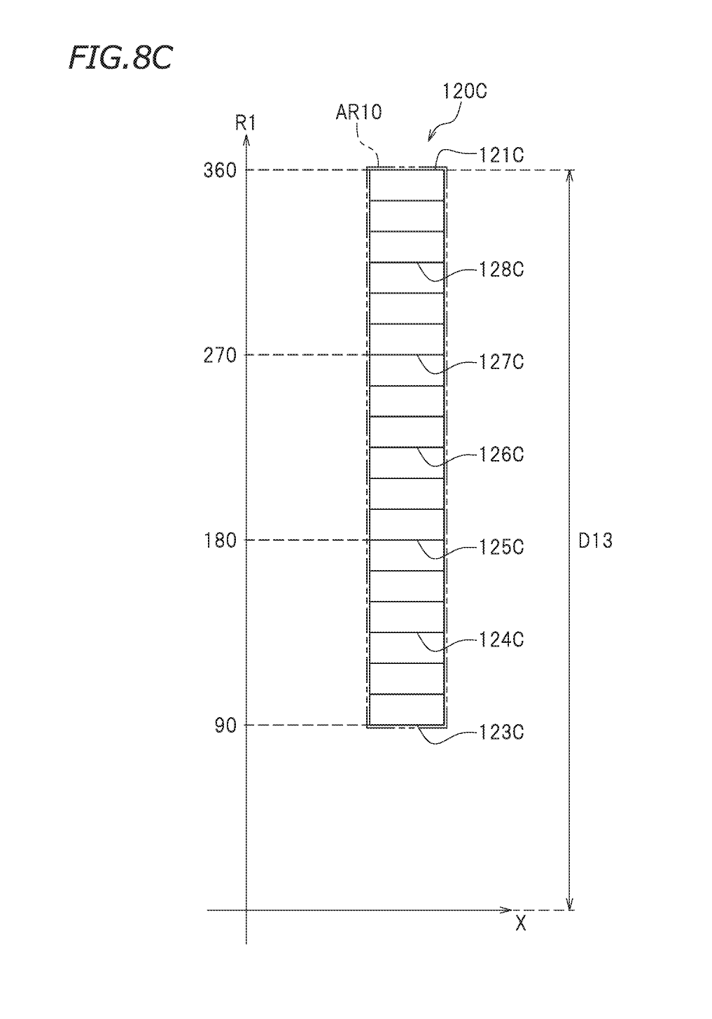

A reference position PN1 is set for the three-dimensional object 110. For example, the reference position PN1 may be defined as a position where the three-dimensional object 110 is disposed in the orientation shown in FIG. 5. When viewed along the axis of the shaft 111 (i.e., when viewed in the direction A indicated in FIG. 4), the thermoplastic resin 38 is discharged from the shaping head 30 into a region AR1 above the shaft 111. Herein, the region AR1 above the shaft 111 is referred to as an “object formation region”. When viewed along the axis of the shaft 111 in the reference position PN1, a line LN1 extending upward from the center C1 of the shaft 111 is defined as a reference line. With the three-dimensional object 110 being disposed at the reference position PN1, the three-dimensional object 110 is rotated, a predetermined angle by the predetermined angle, in a predetermined direction D1 (in an anticlockwise direction herein) about the shaft 111. Herein, the predetermined angle is also referred to as “rotational resolution”. FIG. 7 is a view illustrating the three-dimensional object 110 that has been rotated about the shaft 111 from the position shown in FIG. 5. As illustrated in FIG. 7, when the three-dimensional object 110 is rotated a predetermined angle by the predetermined angle, a line L1 extending upward from the center C1 of the shaft 111 is defined as an angle line. In the present preferred embodiment, the angle defined by the reference line LN1 and the angle line L1 is defined as a rotation angle R1.

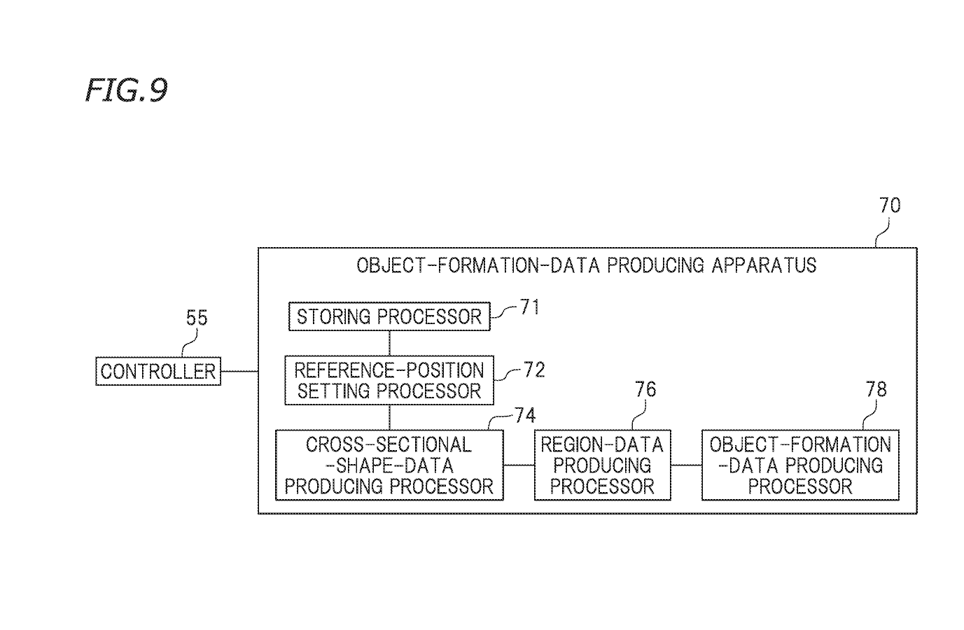

As for the three-dimensional object 110 shown in FIG. 4, a resin layer corresponding to the first layer 112A is formed with the shaft 111 being rotated about its axis of rotation. Next, a resin layer corresponding to the second layer 112B is formed while being rotated about the shaft 111. Thereafter, a resin layer corresponding to the third layer 112C is formed. Thus, in the present preferred embodiment, the resin layers are formed successively from one layer close to the shaft 111 to the next. So, object formation data 120A, 120B, and 120C that are indicative of the respective layers 112A, 112B, and 112C are produced, as illustrated in FIGS. 8A to 8C. The object formation data 120A shown in FIG. 8A are object formation data indicative of the first layer 112A. The object formation data 120B shown in FIG. 8B are object formation data indicative of the second layer 112B. The object formation data 120C shown in FIG. 8C are object formation data indicative of the third layer 112C. The object formation data 120A, 120B, and 120C are produced based on the data of the three-dimensional object 110 shown in FIG. 4, and they are indicative of the respective layers 112A, 112B, and 112C that are developed on a plane. Herein, the object formation data are produced as many as the number of layers that define the three-dimensional object 110.

Next, the object formation data will be described in detail. Because the object formation data 120A, 120B, and 120C have the same format, only the object formation data 120A shown in FIG. 8A will be described herein. As illustrated in FIG. 8A, the vertical axis of the object formation data 120A indicates rotation angles R1. The horizontal axis of the object formation data 120A represents positions along the X-axis. Note that the vertical axis of the object formation data 120A also represents the circumferential length of the surface of the first layer 112A. The object formation lines 121A to 128A indicate the regions of the shaft 111 along its axis that are to be formed at the respective rotation angles R1. Note that in FIG. 8A, the object formation line 121A at a rotation angle R1 of 0 degrees is identical to the object formation line at a rotation angle R1 of 360 degrees. For this reason, the object formation line 121A is shown only at the position where the rotation angle R1 is 360 degrees and not shown at the position where the rotation angle R1 is 0 degrees. The region in which the object formation lines 121A to 128A are shown is a discharge region in which the thermoplastic resin 38 is to be discharged. The region in which the object formation lines 121A to 128A are not shown is a non-discharge region in which the thermoplastic resin 38 is not to be discharged. The gap between adjacent pairs of the object formation lines 121A to 128A corresponds to the above-mentioned predetermined angle, that is, the value of the above-mentioned rotational resolution. When this rotational resolution is smaller, it is possible to form the three-dimensional object 110 with higher precision. In the object formation data 120A shown in FIG. 8, when the rotational resolution is set to be indefinitely small, the gap between a plurality of object formation lines accordingly becomes indefinitely small. In this case, the region AR10 indicated by the dash-dot-dot line is the discharge region. Also in this case, the region other than the discharge region AR10 is the non-discharge region. As for the object formation data 120B of FIG. 8B, which are indicative of the second layer 112B (see FIG. 4), the second layer 112B is not formed in the object formation region AR1 at a rotation angle R1 of about 45 degrees, for example. Accordingly, the object formation line for the second layer 112B does not exist at a rotation angle R1 of about 45 degrees, for example. The object formation data 120B includes the object formation lines 121B and 123B to 128B. Similarly, as for the object formation data 120C of FIG. 8C, which are indicative of the third layer 112C (see FIG. 4), the third layer 112C is not formed in the object formation region AR1 at a rotation angle R1 of about 45 degrees, for example. Accordingly, the object formation line for the third layer 112C does not exist at a rotation angle R1 of about 45 degrees, for example. The object formation data 120C includes the object formation lines 121C and 123C to 128C.

In the present preferred embodiment, the thickness of each of the first layer 112A, the second layer 112B, and the third layer 112C in the three-dimensional object 110 is t, as illustrated in FIG. 5. When forming the layers 112A, 112B, and 112c, the thermoplastic resin 38 is discharged so as to be a constant width and a constant thickness in the object formation region AR1. Herein, a distance D1 from the center C1 of the shaft 111 to the surface of the first layer 112A preferably is t, for example. A distance D2 from the center C1 to the surface of the second layer 112B preferably is 2 t, for example. A distance D3 from the center C1 to the surface of the third layer 112C preferably is 3 t, for example. In other words, the distance D2 preferably is about 2 times the distance D1, for example. The distance D3 preferably is about 3 times the distance D1, for example. Thus, the distance from the center C1 to the surface of a layer that is subsequently formed is greater than the distance from the center C1 to the surface of a layer that has already been formed.

In the present preferred embodiment, the circumferential lengths of the surfaces of the respective layers 112A, 112B, and 112C vary in proportion to the distances from the center C1 to the respective layers 112A, 112B, and 112C. More specifically, the circumferential length D12 (see FIG. 8B) of the surface of the second layer 112B is longer than the circumferential length D11 (see FIG. 8A) of the surface of the first layer 112A. Herein, the length D12 is 2 times the length D11. Also, the circumferential length D13 (see FIG. 8C) of the surface of the third layer 112C is longer than both the circumferential length D11 (see FIG. 8A) of the surface of the first layer 112A and the circumferential length D12 (see FIG. 8B) of the surface of the second layer 112B. Herein, the length D13 preferably is about 3 times the length D11, for example. Therefore, even when the rotational resolution is the same, the layers 112A, 112B, and 112C have different circumferential distances between adjacent rotation angles R1.

In the present preferred embodiment, in order to form the first layer 112A and the second layer 112B with the same level of precision, it is desirable that the rotational resolution for the second layer 112B be smaller than the rotational resolution for the first layer 112A. Specifically, it is desirable that the rotational resolution for the second layer 112B be set to about ½ of the rotational resolution for the first layer 112A, for example. It is desirable that the number of the object formation lines in the second layer 112B be greater than the number of the object formation lines in the first layer 112A. Note that in FIG. 8B, the lines between the object formation lines 121B, 123B to 128B are object formation lines. Likewise, in order to form the first layer 112A and the third layer 112C with the same level of precision, it is desirable that the rotational resolution for the third layer 112C be smaller than the rotational resolution for the second layer 112B and also be smaller than the rotational resolution for the first layer 112A. Specifically, it is desirable that the rotational resolution for the third layer 112C be set to about ⅓ of the rotational resolution for the first layer 112A, for example. It is desirable that the number of the object formation lines in the third layer 112C be greater than the number of the object formation lines in the first layer 112A and also be greater than the number of the object formation lines in the second layer 112B. Note that in FIG. 8C, the lines between the object formation lines 121C, 123C to 128C are object formation lines. Thus, in the present preferred embodiment, it is desirable that different respective rotational resolutions are set for the respective layers 112A, 112B, and 112C. In the present preferred embodiment, the rotational resolution for the first layer 112A corresponds to the “first angle”. Likewise, the rotational resolution for the second layer 112B corresponds to the “second angle”.

In the present preferred embodiment, a plurality of object formation data 120A to 120C such as described above are produced by the object-formation-data producing apparatus 70 (see FIG. 2). The object-formation-data producing apparatus 70 is an apparatus for producing object formation data that are used in forming a desired three-dimensional object 110 based on three-dimensional object formation data representative of the desired three-dimensional object 110. The object-formation-data producing apparatus 70 is electrically connected to the controller 55 of the three-dimensional printing apparatus 20. The object-formation-data producing apparatus 70 transmits the object formation data to the controller 55. The object-formation-data producing apparatus 70 may be either a separate apparatus from the three-dimensional printing apparatus 20 or may be integrated in the three-dimensional printing apparatus 20. For example, the object-formation-data producing apparatus 70 may be a computer, and may include a RAM, a ROM for storing, for example, programs to be executed by a CPU, and the like. Herein, a computer program stored in the computer is used to produce the object formation data. Note that the object-formation-data producing apparatus 70 may be either a dedicated computer designed for the three-dimensional printing system 100 or a general-purpose computer.

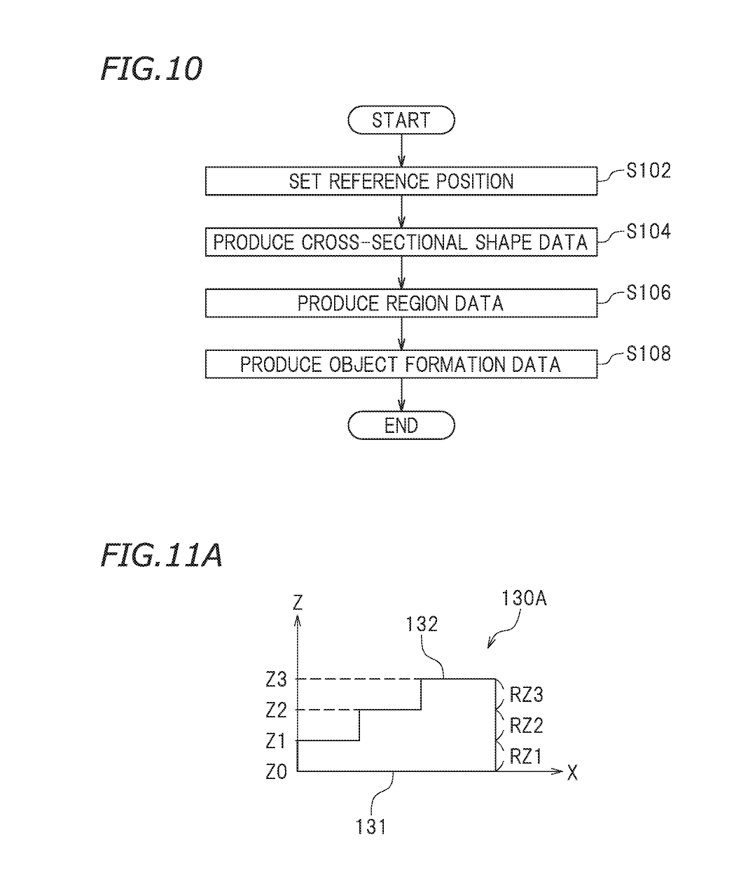

FIG. 9 is a block diagram of the object-formation-data producing apparatus 70. As illustrated in FIG. 9, the object-formation-data producing apparatus 70 includes a storing processor 71, a reference-position setting processor 72, a cross-sectional-shape-data producing processor 74, a region-data producing processor 76, and an object-formation-data producing processor 78. Each of the processors may be a processor or processors implemented by executing a computer program stored in the object-formation-data producing apparatus 70, or a processor or processors implemented by a circuit.

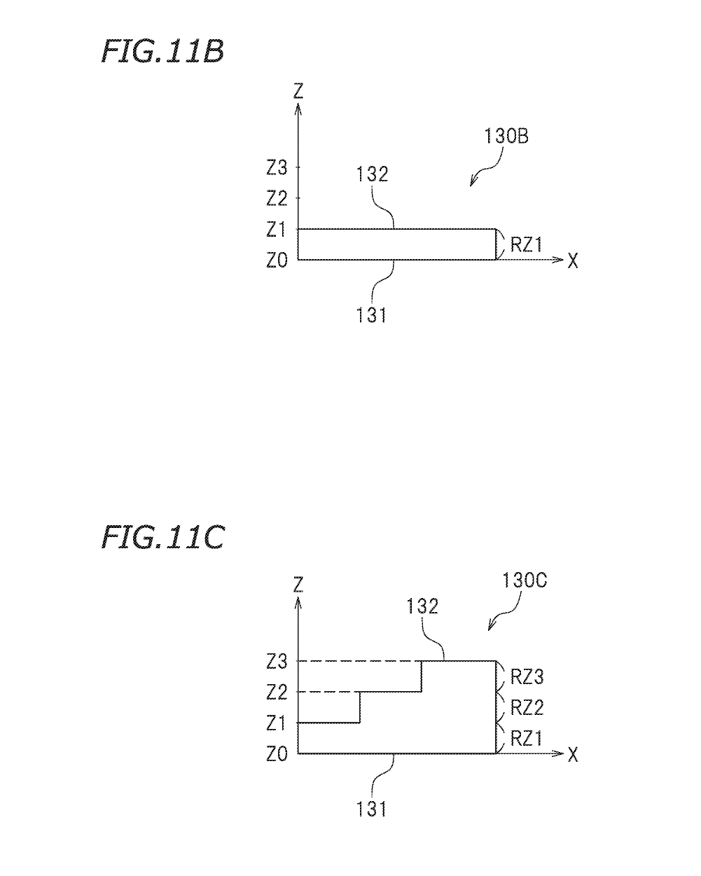

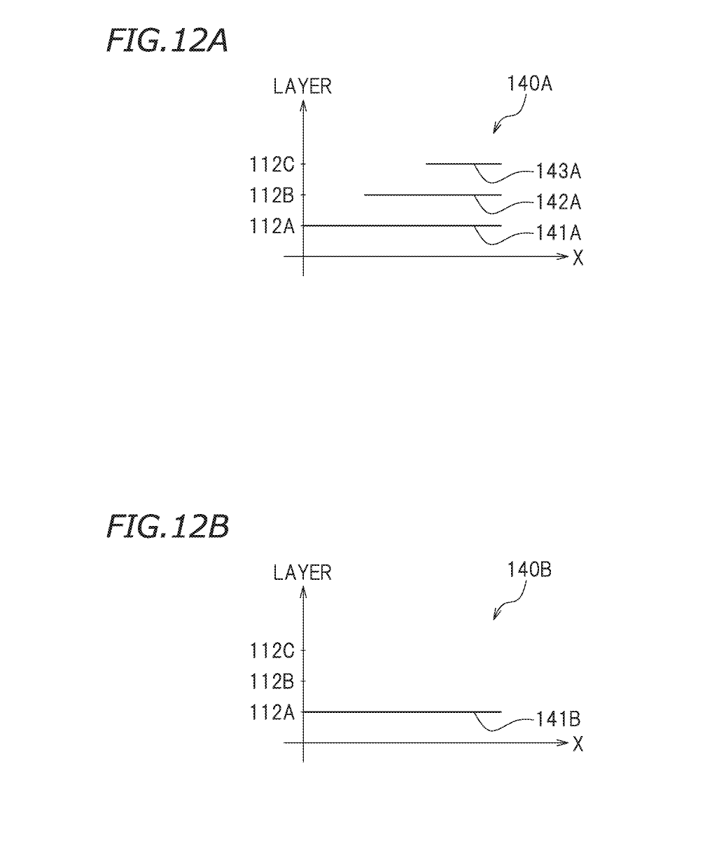

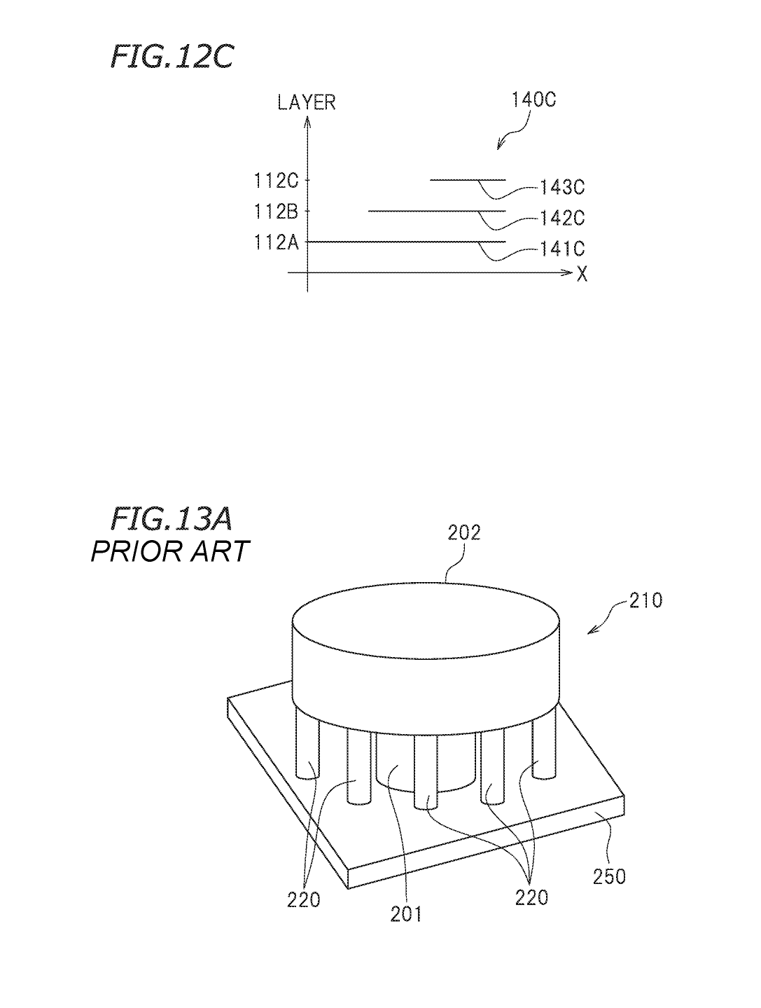

Next, the procedure of producing object formation data by the object-formation-data producing apparatus 70 will be described in detail. FIG. 10 is a flowchart illustrating the procedure of producing the object formation data 120A, 120B, and 120C. Herein, the procedure of producing the object formation data 120A, 120B, and 120C for the three-dimensional object 110 of FIG. 4 will be described with reference to the flow-chart of FIG. 10. In order to produce the object formation data for forming the three-dimensional object 110, cross-sectional shape data 130A, 130B, and 130C (see FIGS. 11A to 11C) and region data 140A, 140B, and 140C (see FIGS. 12A to 12C), which will be described layer, are produced in the present preferred embodiment. Then, the object formation data 120A, 120B, and 120C are produced based on the cross-sectional shape data 130A, 130B, and 130C and the region data 140A, 140B, and 140C. In the present preferred embodiment, the storing processor 71 pre-stores three-dimensional object data representative of the three-dimensional object 110.

In the present preferred embodiment, first, the reference-position setting processor 72 sets a reference position PN1 (see FIG. 4) for the three-dimensional object 110 at step S102 shown in FIG. 10. Herein, for example, the reference position PN1 is such a position that the three-dimensional object 110 is disposed in the orientation as shown in FIG. 4. Note that the reference position PN1 is not limited and it should be determined depending on the shape of the three-dimensional object 110. The information relating to this reference position PN1 is pre-stored in the storing processor 71.

Next, at step S104 in FIG. 10, the cross-sectional-shape-data producing processor 74 produces a plurality of cross-sectional shape data 130A, 130B, and 130C (see FIGS. 11A to 11C). Herein, the cross-sectional-shape-data producing processor 74 produces the plurality of cross-sectional shape data 130A, 130B, and 130C based on the data of the three-dimensional object 110 that are stored in the storing processor 71. In the present preferred embodiment, the term “cross-sectional shape data” indicates data of a cross-sectional shape of the three-dimensional object 110 in the object formation region AR1 (the region above the shaft 111, see FIG. 5), which is rotated by a rotation angle R1 about the shaft 111 from the reference position PN1. The cross-sectional shape is a cross-sectional shape in the X-Z plane.

Herein, the cross-sectional shape data are produced for as many as the number obtained by dividing 360 degrees by the rotational resolution. The value of the rotational resolution is not limited to a specific value. In the present preferred embodiment, the three-dimensional object 110 preferably is formed by three layers, the first layer 112A, the second layer 112B, and the third layer 112C. Each of the layers 112A, 112B, and 112C has an identical thickness t. As already described above, it is desirable that the rotational resolution for the second layer 112B be set to about ½ of the rotational resolution for the first layer 112A, for example. It is desirable that the rotational resolution for the third layer 112C be set to about ⅓ of the rotational resolution for the first layer 112A, for example. Herein, when the rotational resolution for the first layer 112A is about 45 degrees, the rotational resolution for the second layer 112B is about 22.5 degrees, for example. When the rotational resolution for the first layer 112A is about 45 degrees, the rotational resolution for the third layer 112C is about 15 degrees, for example. Accordingly, in the present preferred embodiment, the cross-sectional-shape-data producing processor 74 produces the cross-sectional shape data for as many as the number that includes all the rotation angles R1 corresponding to the respective rotational resolutions for the layers 112A, 112B, and 112C. Specifically, when the rotational resolution for the first layer 112A is about 45 degrees, there are 8 different rotation angles R1, about 0 degrees (about 360 degrees), about 45 degrees, about 90 degrees, about 135 degrees, about 180 degrees, about 225 degrees, about 270 degrees, and about 315 degrees, for example. When the rotational resolution for the second layer 112B is about 22.5 degrees, there are 16 different rotation angles R1, about 0 degrees (about 360 degrees), about 22.5 degrees, about 45 degrees, about 67.5 degrees, about 90 degrees, about 112.5 degrees, about 135 degrees, about 157.5 degrees, about 180 degrees, about 202.5 degrees, about 225 degrees, about 247.5 degrees, about 270 degrees, about 292.5 degrees, about 315 degrees, and about 337.5 degrees, for example. When the rotational resolution for the third layer 112C is about 15 degrees, there are 24 different rotation angles R1, about 0 degrees (about 360 degrees), about 15 degrees, about 30 degrees, about 45 degrees, about 60 degrees, about 75 degrees, about 90 degrees, about 105 degrees, about 120 degrees, about 135 degrees, about 150 degrees, about 165 degrees, about 180 degrees, about 195 degrees, about 210 degrees, about 225 degrees, about 240 degrees, about 255 degrees, about 270 degrees, about 285 degrees, about 300 degrees, about 315 degrees, about 330 degrees, and about 345 degrees, for example. Therefore, the cross-sectional-shape-data producing processor 74 produces 32 different kinds of cross-sectional shape data in the object formation region AR1 at rotation angles R1 of about 0 degrees (about 360 degrees), about 15 degrees, about 22.5 degrees, about 30 degrees, about 45 degrees, about 60 degrees, about 67.5 degrees, about 75 degrees, about 90 degrees, about 105 degrees, about 112.5 degrees, about 120 degrees, about 135 degrees, about 150 degrees, about 157.5 degrees, about 165 degrees, about 180 degrees, about 195 degrees, about 202.5 degrees, about 210 degrees, about 225 degrees, about 240 degrees, about 247.5 degrees, about 255 degrees, about 270 degrees, about 285 degrees, about 292.5 degrees, about 300 degrees, about 315 degrees, about 330 degrees, about 337.5 degrees, and about 345 degrees, for example.

For example, FIG. 11A illustrates the cross-sectional shape data 130A in the object formation region AR1 at a rotation angle R1 of about 0 degrees (about 360 degrees). FIG. 11B illustrates the cross-sectional shape data 130B in the object formation region AR1 at a rotation angle R1 of about 45 degrees. FIG. 11C illustrates the cross-sectional shape data 130C in the object formation region AR1 at a rotation angle R1 of about 90 degrees. Note that the cross-sectional shape data in the object formation region AR1 at other rotation angles R1 are not shown in the drawings.

In the present preferred embodiment, the cross-sectional shape data in the object formation region AR1 at various different rotation angles R1 preferably have the same format. Therefore, only the format of the cross-sectional shape data 130A shown in FIG. 11A will be described in detail herein. As illustrated in FIG. 11A, the vertical axis of the cross-sectional shape data 130A represents positions along the Z-axis. Herein, the Z-axis is in agreement with the stacking direction of the layers 112A, 112B, and 112C (see FIG. 4). The horizontal axis of the cross-sectional shape data 130A represents positions along the X-axis. A region RZ1 between a position Z0 and a position Z1 along the Z-axis represents a region corresponding to the first layer 112A. A region RZ2 between the position Z1 and a position Z2 represents a region corresponding to the second layer 112B. A region RZ3 between the position Z2 and a position Z3 represents a region corresponding to the third layer 112C. In the cross-sectional shape data 130A, a line 131 represents the shaft 111 (see FIG. 4). The contour line 132 represents the contour of the three-dimensional object 110 in the object formation region AR1. Herein, the line 131 and the contour line 132 represent the cross-sectional shape in the object formation region AR1. The region surrounded by the line 131 and the contour line 132 is a discharge region.

In the manner as described above, the cross-sectional-shape-data producing processor 74 produces the cross-sectional shape data 130A, 130B, and 130C for respective rotation angles R1. The cross-sectional shape data 130A, 130B, and 130C produced by the cross-sectional-shape-data producing processor 74 are stored in the storing processor 71.

Next, at step S106 in FIG. 10, the region-data producing processor 76 produces a plurality of region data 140A, 140B, and 140C (see FIGS. 12A to 12C). Herein, the region-data producing processor 76 produces the plurality of region data 140A, 140B, and 140C based on the plurality of cross-sectional shape data 130A, 130B, and 130C which have been produced by the cross-sectional-shape-data producing processor 74. Herein, the term “region data” is data used to classify the object formation region AR1 into the discharge region and the non-discharge region for each of the layers 112A, 112B, and 112C, when the three-dimensional object 110 is rotated about the shaft 111 by a rotation angle R1 from the reference position PN1 (see FIG. 4). Herein, the region data are produced for as many as the number of the cross-sectional shape data 130A, 130B, and 130C. For example, in the present preferred embodiment, the region-data producing processor 76 produces 32 different kinds of region data for the object formation region AR1 at rotation angles R1 of about 0 degrees (about 360 degrees), about 15 degrees, about 22.5 degrees, about 30 degrees, about 45 degrees, about 60 degrees, about 67.5 degrees, about 75 degrees, about 90 degrees, about 105 degrees, about 112.5 degrees, about 120 degrees, about 135 degrees, about 150 degrees, about 157.5 degrees, about 165 degrees, about 180 degrees, about 195 degrees, about 202.5 degrees, about 210 degrees, about 225 degrees, about 240 degrees, about 247.5 degrees, about 255 degrees, about 270 degrees, about 285 degrees, about 292.5 degrees, about 300 degrees, about 315 degrees, about 330 degrees, about 337.5 degrees, and about 345 degrees, for example. The number of the region data and the number of the cross-sectional shape data are equal. For example, FIG. 12A illustrates the region data 140A in the object formation region AR1 at a rotation angle R1 of about 0 degrees (about 360 degrees). FIG. 12B illustrates the region data 140B in the object formation region AR1 at a rotation angle R1 of about 45 degrees. FIG. 12C illustrates the region data 140C in the object formation region AR1 at a rotation angle R1 of about 90 degrees. Note that the region data in the object formation region AR1 at other rotation angles R1 are not shown in the drawings.

In the present preferred embodiment, the region data in the object formation region AR1 at various rotation angles R1 have the same format. Therefore, only the format of the region data 140A shown in FIG. 12A will be described in detail herein. As illustrated in FIG. 12A, the vertical axis of the region data 140A represents the layers 112A, 112B, and 112C. The horizontal axis of the region data 140A represents positions along the X-axis. The region-data producing processor 76 produces the region data 140A shown in FIG. 12A based on the cross-sectional shape data 130A shown in FIG. 11A. Here, the region data 140A include a plurality of discharge lines 141A, 142A, and 143A. The discharge line 141A indicates the discharge region for the first layer 112A. The discharge line 142A indicates the discharge region for the second layer 112B. The discharge line 143A indicates the discharge region for the third layer 112C. The region-data producing processor 76 produces the region data 140A by obtaining the discharge lines 141A, 142A, and 143A, which respectively indicate the layers 112A, 112B, and 112C in the object formation region AR1 at a rotation angle R1 of about 0 degrees (about 360 degrees). Note that, in the region data 140B (see FIG. 12B) of the object formation region AR1 at a rotation angle R1 of about 45 degrees, the discharge line 141B indicating the discharge region for the first layer 112A is present, but the discharge regions for the second layer 112B and the third layer 112C do not exist.

Accordingly, the discharge lines for the second layer 112B and the third layer 112C are not present in the region data 140B. In the region data 140C (see FIG. 12C) in the object formation region AR1 at a rotation angle R1 of about 90 degrees, the discharge regions for the layers 112A, 112B, and 112C exist, so the discharge lines 141C, 142C, and 143C are present. In the manner as described above, the region-data producing processor 76 produces the region data 140A, 140B, and 140C for the respective rotation angles R1. The region data 140A, 140B, and 140C produced by the region-data producing processor 76 are stored in the storing processor 71.

Next, at step S108 in FIG. 10, the object-formation-data producing processor 78 produces a plurality of object formation data 120A, 120B, and 120C as shown in FIGS. 8A to 8C. Here, the object-formation-data producing processor 78 produces the plurality of object formation data 120A, 120B, and 120C based on the plurality of region data 140A, 140B, and 140C (see FIGS. 12A to 12C), which are produced by the region-data producing processor 76. As described previously, the object formation data are data that are produced respectively for the layers 112A, 112B, and 112C. Herein, the object-formation-data producing processor 78 produces three object formation data, 120A, 120B, and 120C.

In the present preferred embodiment, the procedures of producing the object formation data 120A, 120B, and 120C are the same, and therefore, only the procedure of producing the object formation data 120A (see FIG. 8A) indicative of the first layer 112A (see FIG. 4) will be described herein. The object formation data 120A are produced based on the region data 140A, 140B, and 140C at the respective rotation angles R1, which have been produced by the region-data producing processor 76. Herein, the object-formation-data producing processor 78 produces the object formation data 120A from the region data 140A, 140B, and 140C at the respective rotation angles R1 corresponding to the rotational resolution for the first layer 112A. Specifically, the rotational resolution for the first layer 112A is about 45 degrees, so the object formation data 120A are produced from the region data for rotation angles R1 of about 0 degrees (about 360 degrees), about 45 degrees, about 90 degrees, about 135 degrees, about 180 degrees, about 225 degrees, about 270 degrees, and about 315 degrees, for example. The object-formation-data producing processor 78 extracts discharge lines corresponding to the first layer 112A from the region data for the respective rotation angles R1. For example, the object-formation-data producing processor 78 extracts a discharge line 141A (see FIG. 12A), a discharge line 141B (see FIG. 12B), and a discharge line 141C (see FIG. 12C), which correspond to the first layer 112A. Then, the extracted discharge lines 141A, 141B, and 141C are arranged at corresponding positions in the object formation data 120A. For example, the object formation line 121A shown in FIG. 8A corresponds to the discharge line 141A shown in FIG. 12A. The object formation line 122A corresponds to the discharge line 141B shown in FIG. 12B. The object formation line 123A corresponds to the discharge line 141C shown in FIG. 12C. Thus, the object-formation-data producing processor 78 produces the object formation data 120A by arranging the object formation lines 121A to 128A.

In the present preferred embodiment, the rotational resolution for the second layer 112B preferably is about 22.5 degrees, for example. Accordingly, the object formation data 120B for the second layer 112B are produced from 16 kinds of region data at rotation angles R1 of about 0 degrees (about 360 degrees), about 22.5 degrees, about 45 degrees, about 67.5 degrees, about 90 degrees, about 112.5 degrees, about 135 degrees, about 157.5 degrees, about 180 degrees, about 202.5 degrees, about 225 degrees, about 247.5 degrees, about 270 degrees, about 292.5 degrees, about 315 degrees, and about 337.5 degrees, for example. Here, the object formation data 120B for the second layer 112B includes the object formation lines that are arranged based on the discharge lines corresponding to the second layer 112B in the 16 kinds of the region data. Also, in the present preferred embodiment, the rotational resolution for the third layer 112C preferably is about 15 degrees, for example. Accordingly, the object formation data 120C for the third layer 112C are produced from 24 kinds of region data at rotation angles R1 of about 0 degrees (about 360 degrees), about 15 degrees, about 30 degrees, about 45 degrees, about 60 degrees, about 75 degrees, about 90 degrees, about 105 degrees, about 120 degrees, about 135 degrees, about 150 degrees, about 165 degrees, about 180 degrees, about 195 degrees, about 210 degrees, about 225 degrees, about 240 degrees, about 255 degrees, about 270 degrees, about 285 degrees, about 300 degrees, about 315 degrees, about 330 degrees, and about 345 degrees, for example. Here, the object formation data 120C for the third layer 112C includes the object formation lines that are arranged based on the discharge lines corresponding to the third layer 112C in the 24 kinds of the region data.

In the manner as described above, the object-formation-data producing processor 78 produces the object formation data 120A, 120B, and 120C for the respective layers 112A, 112B, and 112C. The object formation data 120A, 120B, and 120C produced by the object-formation-data producing processor 78 are stored in the storing processor 71.

The three-dimensional printing apparatus 20 forms the three-dimensional object 110 using the object formation data 120A, 120B, and 120C (see FIGS. 8A to 8C) that are produced by the object-formation-data producing apparatus 70 in the following manner. First, at the start of object formation, the object-formation-data producing apparatus 70 transmits the object formation data 120A, 120B, and 120C to the controller 55 of the three-dimensional printing apparatus 20. After the controller 55 receives the object formation data 120A, 120B, and 120C, formation of the object is started. Here, the layers are formed successively from one that is closer to the core rod 50 (see FIG. 2) to another. In the present preferred embodiment, first, the first layer 112A is formed on the surface of the core rod 50 using the object formation data 120A indicative of the first layer 112A as illustrated in FIG. 8A. Specifically, the core-rod rotating motor 53 is driven so that the core rod 50 is rotated counterclockwise about the central shaft 51. Then, the thermoplastic resin 38 is discharged from the shaping head 30 to the regions corresponding to the applicable object formation lines according to the rotation angles R1 corresponding to the rotational resolution for the first layer 112A. When the discharge of the thermoplastic resin 38 finishes for all the rotation angles R1, the object formation for the first layer 112A ends. Next, in a similar manner, the second layer 112B is formed on the surface of the first layer 112A using the object formation data 120B indicative of the second layer 112B as illustrated in FIG. 8B. Thereafter, the third layer 112C is formed on the surface of the second layer 112B using the object formation data 120C indicative of the third layer 112C as illustrated in FIG. 8C, such that the object formation for the three-dimensional object 110 ends. It is also possible that, after the shaping head 30 has discharged the thermoplastic resin 38 around the core rod 50 to stack the resin layers formed by the thermoplastic resin 38, a finishing process of scraping the surface of the three-dimensional object 110 may be performed by the cutting head 40.

After formation of the three-dimensional object 110 by the three-dimensional printing apparatus 20 is completed, the core rod 50 is able to be removed from the housing 22. This completes the formation of the three-dimensional object 110, in which the core rod 50 is integrated with the resin layers formed of the thermoplastic resin 38.

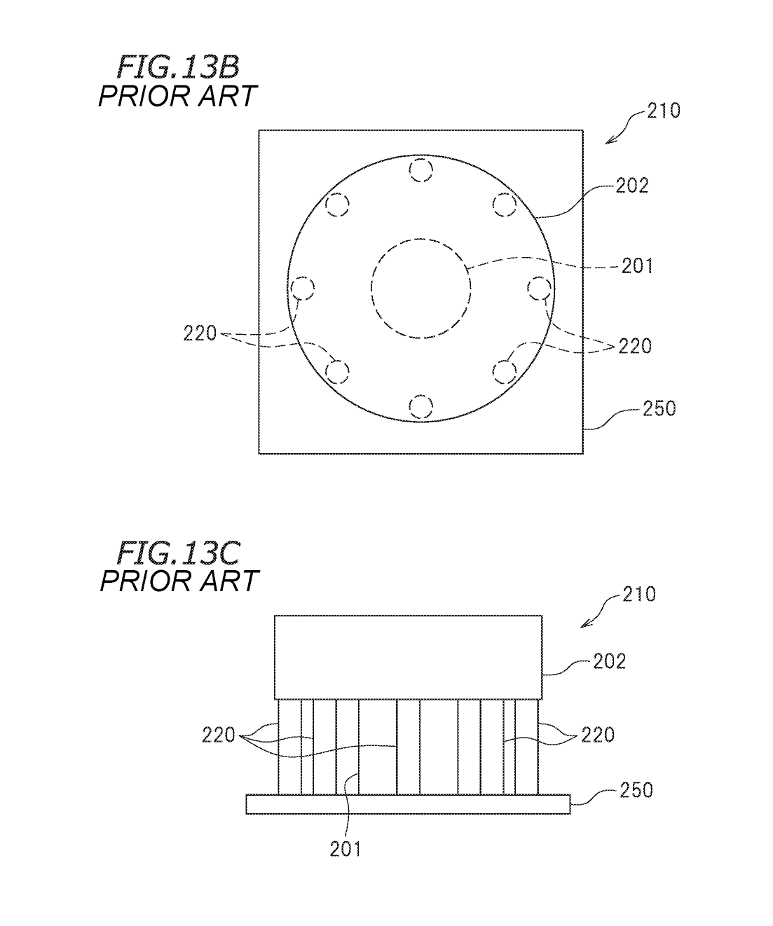

Thus, the present preferred embodiment makes it possible to form, for example, the three-dimensional object 110 as shown in FIG. 4 by stacking resin layers (resin layers corresponding to the layers 112A, 112B, and 112C) formed of the thermoplastic resin 38 around the core rod 50 while rotating the core rod 50. For example, even the three-dimensional object 210 as shown in FIG. 13A can be formed by disposing the core rod 50 at a position inside the three-dimensional object 210 and extending along the vertical axis in FIG. 13A. In this case, the three-dimensional object 210 is formed so that the axis of the central shaft 51 is along the vertical axis in FIG. 13. As a result, because it is unnecessary to form the support objects 220 as shown in FIG. 13A, the amount of resin material used in forming the three-dimensional object 210 is able to be reduced.

In the present preferred embodiment, the housing 22 accommodates the shaping head 30, the core rod 50, and the pair of first guide rails 61, as illustrated in FIG. 2. The core rod 50 is rotatably supported on the housing 22. This enables the core rod 50 to rotate about the central shaft 51 relative to the housing 22, without rotating the housing 22.

In the present preferred embodiment, the core rod 50 is supported detachably on the housing 22. More specifically, the left end of the core rod 50 is detachably supported by the first support member 54, and the right end of the core rod 50 is detachably supported by the second support member 56. As a result, the core rod 50 is able to be removed from the housing 22 after the resin layers formed by the thermoplastic resin 38 have been stacked around the core rod 50 and the three-dimensional object 110 has been formed. Thus, it is possible to form the three-dimensional object 110 in which the core rod 50 is integrated with a plurality of resin layers.

In the present preferred embodiment, the core rod 50 preferably is formed of a resin. This enables the core rod 50 to be an integral part of the three-dimensional object 110 without removing the core rod 50 from the resin layers after forming the three-dimensional object 110. As a result, the work of removing the core rod 50 from the resin layers is eliminated.

In the present preferred embodiment, the reference-position setting processor 72 shown in FIG. 9 sets the reference position PN1 (see FIG. 4), which is a predetermined position of reference for the three-dimensional object 110. An angle from the reference position PN1 by which the three-dimensional object is rotated, a predetermined angle by the predetermined angle, about the shaft 111 from the reference position PN1 is defined as a rotation angle R1, and a region above the shaft when the three-dimensional object is rotated to reach a predetermined rotation angle R1 is defined as an object formation region AR1 (see FIG. 5). The object-formation-data producing processor 78 of FIG. 9 produces the object formation data 120A, 120B, and 120C (see FIGS. 8A to 8C), each designating a discharge region in which the thermoplastic resin 38 is to be discharged, within the object formation region AR1 of the three-dimensional object 110 that is rotated to reach a predetermined rotation angle R1, respectively for the plurality of layers 112A, 112B, and 112C. The object formation data 120A, 120B, and 120C are data used to classify the object formation region AR1 into a discharge region in which the thermoplastic resin 38 is to be discharged and a non-discharge region in which the thermoplastic resin 38 is not to be discharged. Thus, the object formation data 120A, 120B, and 120C are able to be produced for the respective layers 112A, 112B, and 112C of the three-dimensional object 110. As a result, the three-dimensional printing apparatus 20 is able to successively form the layers 112A, 112B, and 112C around the core rod 50 using the object formation data 120A, 120B, and 120C. Thus, it is possible to produce the object formation data 120A, 120B, and 120C that is able to be used appropriately in the three-dimensional printing apparatus 20 according to the present preferred embodiment.

In the present preferred embodiment, the circumferential length D12 (see FIG. 8B) of the surface of the second layer 112B is longer than the circumferential length D11 (see FIG. 8A) of the surface of the first layer 112A. For this reason, if the rotational resolution for the first layer 112A and the rotational resolution for the second layer 112B are set to the same value, the layers 112A and 112B may be formed at different levels of precision. In the present preferred embodiment, however, the object-formation-data producing processor 78 produces the object formation data 120A and 120B so that the rotational resolution used in forming the object formation data 120B for the second layer 112B is set to be smaller than the rotational resolution used in forming the object formation data 120A for the first layer 112A. As a result, both of the layers 112A and 112B are able to be formed with the same level of precision.

In the present preferred embodiment, the region-data producing processor 76 produces, at various rotation angles R1, the region data 140A, 140B, and 140C (see FIGS. 12A to 12C) each classifying the object formation region AR1 of the three-dimensional object 110 that is rotated about the shaft 111 to reach one of the rotation angles R1 into a discharge region and a non-discharge region, for the plurality of layers 112A, 112B, and 112C. The object-formation-data producing processor 78 produces the object formation data 120A, 120B, and 120C respectively for the plurality of the layers 112A, 112B, and 112C based on the discharge regions and the non-discharge regions of the corresponding layers in the region data 140A, 140B, and 140C. When the region data 140A, 140B, and 140C are produced as described above prior to producing the object formation data 120A, 120B, and 120C, the object formation data 120A, 120B, and 120C are able to be produced easily.

In the present preferred embodiment, the cross-sectional-shape-data producing processor 74 produces the cross-sectional shape data 130A, 130B, and 130C (see FIGS. 11A to 11C), which are indicative of a cross-sectional shape of the three-dimensional object 110 in the object formation region AR1 when the three-dimensional object 110 is rotated about the shaft 111 to reach a rotation angle R1. The region-data producing processor 76 produces the region data 140A, 140B, and 140C for each of the rotation angles R1 based on the cross-sectional shape data 130A, 130B, and 130C. This classifies the object formation region AR1 into the discharge region and the non-discharge region easily, because the region data 140A, 140B, and 140C and the object formation data 120A, 120B, and 120C are produced utilizing the cross-sectional shape data 130A, 130B, and 130C, which represent the cross-sectional shapes of the object formation region AR1.

In the present preferred embodiment, the object-formation-data producing apparatus 70 produces the object formation data 120A, 120B, and 120C based on the cross-sectional shape data 130A, 130B, and 130C and the region data 140A, 140B, and 140C. However, the object-formation-data producing apparatus 70 may produce the object formation data 120A, 120B, and 120C directly from the data of the three-dimensional object 110, without producing the cross-sectional shape data 130A, 130B, 130C or the region data 140A, 140B, 140C prior to producing the object formation data 120A, 120B, and 120C.

As described above, the storing processor 71, the reference-position setting processor 72, the cross-sectional-shape-data producing processor 74, the region-data producing processor 76, and the object-formation-data producing processor of the object-formation-data producing apparatus 70 may be implemented by software. That is, each of the processors may be implemented by a computer that executes a computer program that is loaded in the computer. A preferred embodiment of the present invention includes a computer program to perform printing, to enable a computer to function as any of the above-described processors. A preferred embodiment of the present invention also includes a computer readable recording medium in which the computer program is recorded. Each of the above-described processors may be implemented by a single processor provided in the object-formation-data producing apparatus 70, or a plurality of processors provided in the object-formation-data producing apparatus 70. A preferred embodiment of the present invention also includes a circuit that implements the same functions as those implemented by the programs executed by the respective processors. In that case, it is possible that the storing processor 71, the reference-position setting processor 72, the cross-sectional-shape-data producing processor 74, the region-data producing processor 76, and the object-formation-data producing processor 78 may be replaced with a storing circuit 71, a reference position setting circuit 72, a cross-sectional shape data producing circuit 74, a region data producing circuit 76, and an object-formation-data producing circuit 78, respectively.

The terms and expressions which have been used herein are used as terms of description and not of limitation. There is no intention in the use of such terms and expressions of excluding any equivalents of any of the features shown or described, or portions thereof, and it is recognized that various modifications are possible within the scope of the present invention claimed. The present invention may be embodied in many different forms. This disclosure should be considered as providing exemplary preferred embodiments of the principles of the present invention. These preferred embodiments are described herein with the understanding that such preferred embodiments are not intended to limit the present invention to any specific preferred embodiments described and/or illustrated herein. The present invention is not limited to specific preferred embodiments described herein. The present invention encompasses all the preferred embodiments including equivalents, alterations, omissions, combinations, improvements, and/or modifications that can be recognized by those skilled in the arts based on this disclosure. Limitations in the claims should be interpreted broadly based on the language used in the claims, and such limitations should not be limited to specific preferred embodiments described in the present description or provided during prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus comprising:
a core rod including a central shaft;
a rotation mechanism that rotates the core rod about the central shaft;
a guide rail extending along an axis of the core rod and disposed above the core rod;
a shaping head that is slidably engaged with the guide rail and discharges a thermoplastic resin to the core rod; and
a moving mechanism that moves the shaping head along the guide rail.

2. The three-dimensional printing apparatus according to claim 1, further comprising:
a housing accommodating the core rod, the guide rail, and the shaping head; wherein
the core rod is rotatably supported on the housing.

3. The three-dimensional printing apparatus according to claim 2, wherein the core rod is detachably supported on the housing.

4. The three-dimensional printing apparatus according to claim 1, wherein the core rod is made of a resin.

5. An object-formation-data producing apparatus for producing object formation data used in a three-dimensional printing apparatus according to claim 1 to form a three-dimensional object including a shaft and a plurality of layers stacked around the shaft, the object-formation-data producing apparatus is configured or programmed to include:
a storing processor that stores data of the three-dimensional object;
a reference-position setting processor that sets a reference position serving as a predetermined position of reference for the three-dimensional object; and
an object-formation-data producing processor that produces object formation data respectively indicative of the plurality of layers, each of the object formation data designating a discharge region in which the thermoplastic resin is to be discharged, within an object formation region of the three-dimensional object that is rotated so as to reach a rotation angle, wherein the rotation angle is defined as an angle from the reference position by which the three-dimensional object is rotated, a predetermined angle by the predetermined angle, about the shaft from the reference position, and the object formation region is a region above the shaft when the three-dimensional object is rotated to reach the rotation angle.

6. The object-formation-data producing apparatus according to claim 5, wherein the object-formation-data producing processor produces the object formation data respectively indicative of the plurality of layers, each of the object formation data classifying the object formation region of the three-dimensional object that is rotated so as to reach the rotation angle into the discharge region and a non-discharge region in which the thermoplastic resin is not to be discharged.

7. The object-formation-data producing apparatus according to claim 5, wherein the plurality of layers include:
a first layer in contact with the shaft; and
a second layer in contact with the first layer; wherein
the object-formation-data producing processor produces object formation data for the first layer and object formation data for the second layer so that, when forming the object formation data for the first layer, the predetermined angle is set to a first angle, and when forming the object formation data for the second layer, the predetermined angle is set to a second angle that is smaller than the first angle.

8. The object-formation-data producing apparatus according to claim 5, further comprising:
a region-data producing processor that produces region data respectively indicative of the plurality of layers, each of the region data designating the discharge region in the object formation region when the three-dimensional object is rotated so as to reach the rotation angle;
the object-formation-data producing processor produces the object formation data respectively for the plurality of layers based on the discharge regions of the corresponding layers in the region data.

9. The object-formation-data producing apparatus according to claim 5, further comprising:
a cross-sectional-shape-data producing processor that produces cross-sectional shape data each indicative of a cross-sectional shape of the three-dimensional object in the object formation region when the three-dimensional object is rotated so as to reach the rotation angle;
the region-data producing processor produces the region data based on the cross-sectional shape data.
